(19) United States
(12) Patent Application Publication
(10) Pub. No.: US 2020/0065447 A1
(43) Pub. Date: Feb. 27, 2020

(54) METHOD FOR FIXTURE SHAPE OPTIMIZATION DESIGN OF SPACE MEMBRANE STRUCTURE FOR INHIBITING WRINKLING

(71) Applicant: Dalian University of Technology, Dalian City (CN)

(72) Inventors: Yangjun LUO, Dalian City (CN); Jian XING, Dalian City (CN); Zhan KANG, Dalian City (CN); Ming LI, Dalian City (CN)

(21) Appl. No.: 16/346,513

(22) PCT Filed: Dec. 20, 2018
(86) PCT No.: PCT/CN2018/122264

§ 371 Date: Apr. 30, 2019

(30) Foreign Application Priority Data
Dec. 21, 2017 (CN) 201711388553.9

(51) Int. Cl. G06F 17/50

(52) U.S. Cl. CPC G06F 17/5018; G06F 2217/16

(57) ABSTRACT

A method for fixture shape optimization design of a space membrane structure for inhibiting wrinkling, and solves the problem that the space membrane structure is easy to generate a wrinkling phenomenon under the stretching effect of a traditional fixture. By optimizing the shape of the fixture and changing the loading boundary conditions, the minor principal stress of the unit in the membrane region is maximized and the distribution of the principal stress of the membrane is regulated. A global optimization algorithm is used to find a global optimal design, and then novel fixture forms with “arch” and “convex” boundaries are obtained, to achieve the purpose of completely simulating the wrinkling. The present invention not only inhibits the generation of the wrinkling in the membrane, but also avoids cutting the membrane and ensures that the membrane has large enough working area.

### TECHNICAL FIELD

The present invention belongs to the field of design of aerospace membrane structures, and relates to a method for fixture shape optimization design of a space membrane structure.

### BACKGROUND

A flexible membrane has the advantages of light weight, large deformation and easy folding/unfolding, and is widely used in aerospace structures. The membrane and an unfolding mechanism are connected by a rigid fixture, and a tension stress is generated in the membrane surface after the membrane is unfolded in space, so as to achieve its specific functions. However, because the membrane can hardly bear a compressive stress in the surface, it is prone to out-of-surface buckling under an external load, i.e., a wrinkling phenomenon. The physical test and finite element analysis of a structural form given by traditional design show that: a space membrane structure, after unfolded, is easy to generate a large number of wrinkling, which will seriously affect the shape accuracy and the use performance of the space structure. In view of this problem, by digging holes inside or at the edge of the membrane, the area of the membrane will be inevitably reduced though wrinkling can be inhibited. In order to obtain an effective structural form which ensures high-precision shape requirements and has large enough membrane working area, a very effective method is to adopt a means of optimization design to redesign the fixture structural form and adjust the stress distribution inside the membrane by changing the displacement load boundary condition of the membrane, to increase the minor principal stress throughout the membrane to a positive value, so as to achieve an expected complete tension state.

### SUMMARY

With respect to high-precision shape requirements and large-area working membrane surface requirements of a space membrane, the present invention provides a method for shape optimization design of a supporting fixture. The method can enhance the minor principal stress of the membrane, inhibit the generation of wrinkling in the membrane and ensure that the membrane has large enough working area. The present invention is suitable for fixture design of space membrane structures such as space antennas and solar sails, is favorable for simulating membrane wrinkling and ensuring working performance of the structure, and does not add any manufacturing, transmitting and operating cost.

To achieve the above purpose, the present invention adopts the following technical solution:

A method for fixture shape optimization design of a membrane structure for inhibiting wrinkling mainly comprises two parts of fixture component shape optimization and numerical verification of a space membrane structure, and comprises the following specific steps:

Step 1. Conducting Shape Optimization on a Fixture Component

A membrane fixture edge line given by traditional design is generally a straight line. After a displacement stretching load effect is applied through a fixture, the local minor principal stress of the membrane is zero or negative, so that a wrinkling phenomenon occurs, which does not meet shape requirements. In order to obtain the space membrane structure which meets membrane surface accuracy design requirements and area requirements, the present invention redesigns a fixture form through a shape optimization means so that the minor principal stress of the membrane is a positive and wrinkling is inhibited.

1.1) Determining a design domain, dividing finite element unit grids and establishing a membrane structure finite element model with a fixture according to structural dimensional requirements and actual loading conditions; simulating a rigid fixture component by using material with large elastic modulus in the membrane structure finite element model; and selecting a plurality of design points from a connecting line of a membrane and the fixture, and generating a fixture and membrane boundary through B-spline function interpolation, wherein the elastic modulus of the material of the fixture is not less than 1000 times of that of the membrane.

1.2) Applying a displacement load to the rigid fixture, and analyzing the membrane structure finite element model through a nonlinear finite element analysis method.

1.3) Designing an edge line of the fixture and building a shape optimization model with a final design goal of maximizing a minor principal stress within a membrane region:

(a) goal: maximizing the minor principal stress within the membrane region, namely

$$max \{ {min}_{e ∈ {Ω}_{m}} {S}_{2}^{e} \} ,$$

wherein e is a finite element unit number, S₂ is the minor principal stress and Ωₘ is the membrane region;

(b) constraint: determining a membrane area consumption as a constraint lower limit, wherein the area consumption is not less than 95% of an initial membrane area;

(c) design variable: coordinates of design points on the edge line.

1.4) Conducting aggregation transfer on a min-max optimizing goal according to the shape optimization model established in step 1.3) to obtain an equivalent optimization target function, wherein the aggregation transfer comprises a p-norm method; the expression of p-norm aggregation function is

$${min ( {\sum }_{e ∈ {Ω}_{m}} {( max \{ 0 , {S}^{*} - {S}_{2}^{e} \} )}^{p} )}^{1 / p} ,$$

wherein S* is an expected minor principal stress, which is 0.1-1.0; and p is an aggregation parameter, which is 20-50.

1.5) Solving by a global optimization algorithm according to the shape optimization model established in steps 1.3) and 1.4) to obtain a global optimal solution of the fixture shape optimization problem, wherein the optimization algorithm is a surrogate model algorithm, a genetic algorithm or an optimization algorithm based on gradient.

Step 2. Numerically Verifying the Space Membrane Structure

Conducting nonlinear post-buckling analysis by introducing a membrane random defect based on an optimized fixture form obtained in the first step 1.5), and verifying an effect of the optimized space membrane structure.

The present invention has the beneficial effects: before optimization, the fixture is in a straight line form. The membrane region has the minor principal stress which is zero is negative under the effect of the stretching load, thereby producing wrinkling and not meeting high-precision shape requirements. After the “curved edge” fixture is obtained by the method of the present invention, the membrane does not generate wrinkling under the load effect, and the minor principal stress is a positive value, which can also ensure the membrane area. The fixture is simple in configuration, easy to process and manufacture, and conducive to assembly and space unfolding, and is subjected to finite element analysis and ground static test verification. The structure meets performance requirements.

### DESCRIPTION OF DRAWINGS

FIG. 1 shows a design domain of a space membrane antenna structure provided in embodiments of the present invention. In the figure: ūₚᵣₑ indicates a displacement load applied to a fixture.

FIG. 2(a) is an optimal design diagram of a single fixture of a space membrane antenna structure.

FIG. 2(b) is an effect diagram of a space membrane antenna structure obtained by design with a method of the present invention.

FIG. 3 shows a design domain of a solar sail structure provided in embodiments of the present invention.

FIG. 4(a) is an optimal design diagram of a single fixture of a solar sail structure.

FIG. 4(b) is an effect diagram of a solar sail structure obtained by design with a method of the present invention.

### DETAILED DESCRIPTION

Specific embodiments of the present invention are described below in detail in combination with the technical solution and accompanying drawings.

Step 1. Conducting Shape Optimization on a Fixture Component

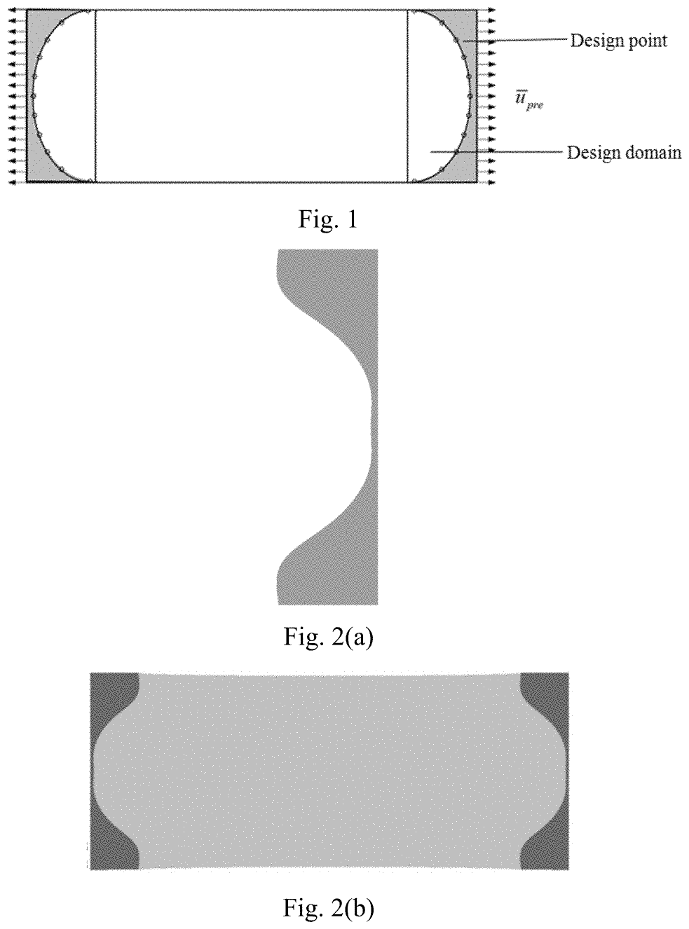

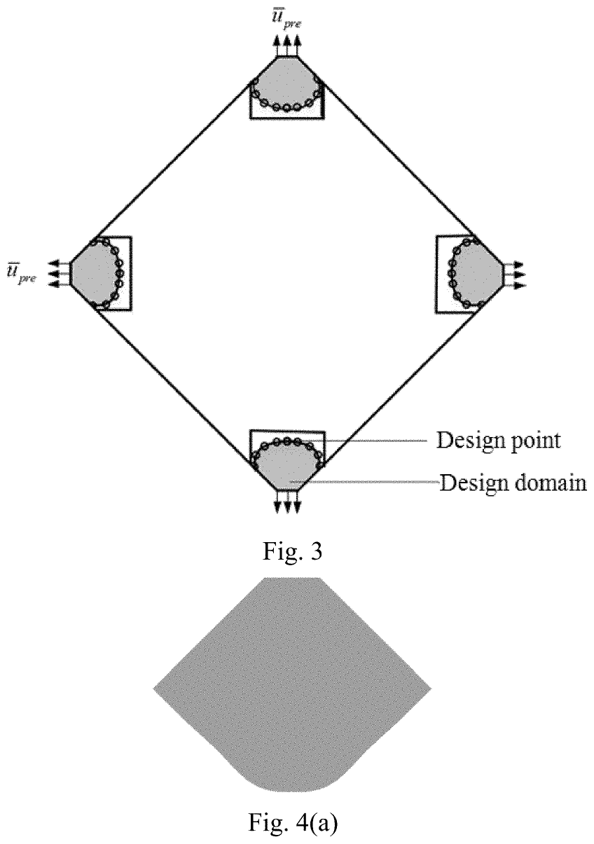

1.1) Determining a design domain, dividing finite element unit grids and establishing a membrane structure finite element model with a fixture according to structural dimensional requirements and actual loading conditions; simulating a rigid fixture component by using material with large elastic modulus which is 1000 times of that of a membrane; and selecting a plurality of design points from a connecting line of the membrane and the fixture, and generating a fixture and membrane boundary through B-spline function interpolation, wherein FIG. 1 shows a design domain of a space membrane antenna structure, and 11 design points are selected by each fixture according to structural up-down symmetry, and FIG. 3 shows a design domain of a solar sail structure, and 9 design points are selected by each fixture according to the symmetry; two initial structures have obvious wrinkling behaviors under the effect of the stretching load;

1.2) applying a displacement load to the rigid fixture, and analyzing the membrane structure finite element model through a nonlinear finite element analysis method to obtain the minor principal stress of each unit;

1.3) Designing an edge line of the fixture and building a shape optimization model with a final design goal of maximizing a minor principal stress within a membrane region:

(a) goal: maximizing the minor principal stress within the membrane region, namely

$$max \{ {min}_{e ∈ {Ω}_{m}} {S}_{2}^{e} \} ,$$

wherein e is a finite element unit number, S₂ is the minor principal stress and Ωₘ is the membrane region;

(b) constraint: determining a membrane area consumption as a constraint lower limit, wherein the area consumption is 95% of an initial membrane area;

(c) design variable: coordinates of design points on the edge line.

1.4) Conducting aggregation transfer on a min-max optimizing goal according to the shape optimization model established in step 1.3), wherein the aggregation transfer is

$${min ( {\sum }_{e ∈ {Ω}_{m}} {( max \{ 0 , {S}^{*} - {S}_{2}^{e} \} )}^{p} )}^{1 / p} ,$$

S* is an expected minor principal stress, which is 0.5; and p is an aggregation parameter, which is 20;

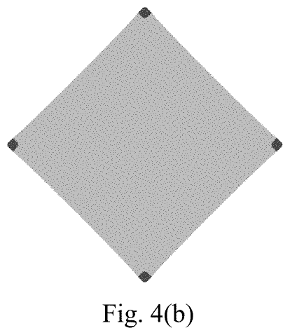

1.5) solving by a global optimization algorithm (such as Kriging surrogate model method) according to shape optimization problems established in steps 1.3) and 1.4) to obtain a global optimal solution of the fixture shape optimization problem to finally obtain fixture forms with “arch” and “convex” boundaries, wherein fixture shapes of the space membrane antenna and the solar sail are respectively shown in FIG. 2(a) and FIG. 4(a).

Step 2. Numerically Verifying the Space Membrane Structure

Conducting nonlinear post-buckling analysis by introducing a membrane random defect based on an optimized fixture form obtained in the first step 1.5), and verifying an effect of the optimized space membrane structure. The result shows that, the optimized “arch” fixture (as shown in FIG. 2(b), the displacement is close to 0 outside the membrane surface, and there is no local wrinkling phenomenon; in the figure, darker colors on both sides indicate the fixtures, and the light gray region indicates the membrane) and the “convex” fixture (as shown in FIG. 4(b), the displacement is close to 0 outside the membrane surface, and there is no local wrinkling phenomenon; in the figure, the black regions on four corners indicate the fixtures, and the light gray region indicates the membrane) are respectively conductive to enhancing the minor principal stress of the membranes of two structures, thereby avoiding the local wrinkling phenomenon and meeting the high-precision shape requirements without cutting the membranes or adding the operating cost.

1. A method for fixture shape optimization design of space membrane structure for inhibiting wrinkling, wherein the steps are as follows:
step 1. conducting shape optimization on a fixture component
1.1) determining a design domain, dividing finite element unit grids and establishing a membrane structure finite element model with a fixture according to structural dimensional requirements and actual loading conditions; simulating a rigid fixture component by using material with large elastic modulus in the membrane structure finite element model; and selecting a plurality of design points from a connecting line of a membrane and the fixture, and generating a fixture and membrane boundary through B-spline function interpolation;
1.2) applying a displacement load to the rigid fixture, and analyzing the membrane structure finite element model through a nonlinear finite element analysis method;
1.3) designing an edge line of the fixture and building a shape optimization model with a final design goal of maximizing a minor principal stress within a membrane region:
(a) goal: maximizing the minor principal stress within the membrane region, namely
$$max \{ {min}_{e ∈ {Ω}_{m}} {S}_{2}^{e} \} ,$$
wherein e is a finite element unit number, S₂ is the minor principal stress and Ωₘ is the membrane region;
(b) constraint: determining a membrane area consumption as a constraint lower limit, wherein the area consumption is not less than 95% of an initial membrane area;
(c) design variable: coordinates of design points on the edge line;
1.4) conducting aggregation transfer on a min-max optimizing goal according to the shape optimization model established in step 1.3);
1.5) solving by a global optimization algorithm according to shape optimization problems established in steps 1.3) and 1.4) to obtain a global optimal solution of the fixture shape optimization problem;
step 2. numerically verifying the space membrane structure
conducting nonlinear post-buckling analysis by introducing a membrane random defect based on an optimized fixture form obtained in the first step 1.5), and verifying an effect of the optimized space membrane structure.

2. The method for fixture shape optimization design of the space membrane structure for inhibiting wrinkling according to claim 1, wherein the elastic modulus of the material in step 1.1) is not less than 1000 times of that of the membrane.

3. The method for fixture shape optimization design of the space membrane structure for inhibiting wrinkling according to claim 1, wherein the aggregation transfer in step 1.4) comprises a p-norm method; the expression of p-norm aggregation function is
$${min ( {\sum }_{e ∈ {Ω}_{m}} {( max \{ 0 , {S}^{*} - {S}_{2}^{e} \} )}^{p} )}^{1 / p} ,$$
wherein S* is an expected minor principal stress, which is 0.1-1.0; and p is an aggregation parameter, which is 20-50.

4. The method for fixture shape optimization design of the space membrane structure for inhibiting wrinkling according to claim 1, wherein the optimization algorithm in step 1.5) is a surrogate model algorithm, a genetic algorithm or an optimization algorithm based on gradient.

5. The method for fixture shape optimization design of the space membrane structure for inhibiting wrinkling according to claim 3, wherein the optimization algorithm in step 1.5) is a surrogate model algorithm, a genetic algorithm or an optimization algorithm based on gradient.
